(19) United States
(12) Patent Application Publication
(10) Pub. No.: US 2007/0085925 A1
(43) Pub. Date: Apr. 19, 2007

(54) Digital camera apparatus

(75) Inventor: Osmo Schroderus, Sumiainen (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/253,249

(22) Filed: Oct. 18, 2005

(51) Int. Cl. H04N 5/222

(52) U.S. Cl. 348/333.02

(57) ABSTRACT

According to one aspect of the present invention, there is provided a digital camera apparatus including an image sensor; a memory for a long-term storing of a still photograph and/or a video taken by means of the image sensor; a monitor screen for displaying a view taken by means of the image sensor and/or an image data stored in the memory; a graphic controller for displaying a mark on the screen and capable of skewing the mark on the screen; a user interface for supplying to the graphic controller a signal initiating to change an amount of the skewing of the mark, and; an image processor for correcting an image data based on the amount of the skewing.

### FIELD OF THE INVENTION

The present invention relates to a digital camera with an image correction function, and may be especially beneficial for digital cameras using kinds of electrical rolling shutters or focal-plane shutters.

### BACKGROUND OF THE INVENTION

The digital camera is now the most popular imaging device. In addition to the dedicated camera system, there are lots of commercial products comprising integrated digital cameras. For example, there are lots of mobile phones, personal computers, PDAs, and audio players having a digital camera. Digital cameras take still pictures or videos by means of image sensors in spite of using traditional films. Image sensors convert incident light to electric signals. Digital cameras construct still pictures or videos from the output signal of the image sensors.

There are two types of popular image sensors for digital cameras, the one is CMOS sensor and the other is CCD sensor. Compared to CCD sensors, CMOS sensors can be produced by easier processes. So it can be said that CMOS sensors are superior to the possible amount of supply and cost. Because of this reason CMOS sensors are used widely for low range digital cameras or camera modules for mobile phones or PDAs.

Digital cameras using CMOS or CCD sensors do not necessarily comprise a mechanical shutter. The shutter function can be realized electronically. FIG. 1 illustrates the way of electronic shutter used in CMOS sensor. FIG. 1a illustrates a CMOS sensor having N′N pixels. When taking a picture, data acquisition, i.e. converting incident light to the electronic signal is performed line by line. At first, pixels belonging to the first line of the CMOS sensor are activated and are used for data acquisition (FIG. 1b). The signals from each pixel of the top line are transferred to the post circuit. Second, pixels belonging to the second top line of the CMOS sensor are activated, and data acquisition is performed by means of the second line (FIG. 1c). Accordingly, data acquisition is performed by means of the third line (FIG. 1d), the forth line (FIG. 1e) in order, until the data acquisition of the last line is take place (FIG. 1f). This type of shutter function is called as electric focal-plane shutter, or Electric Rolling Shutter (ERS). Because of the characteristic of the CMOS sensors, most of the CMOS sensor equipped digital cameras use ERS.

However, as the ERS is line-by-line data taking, there must be a time difference between acquiring the first line and acquiring the last line. This time difference causes an image distortion if a user takes a moving object. FIG. 2 illustrates this image distortion. Suppose that a user is trying to take a picture of a moving car such as illustrated in FIG. 2a. In FIG. 2a the car is moving toward the left direction. If the user takes a picture by a digital camera using a CMOS image sensor and the ERS, the car in the picture will be skewed as illustrated in FIG. 2b. As shown in FIG. 2b, lower parts of the car are shifted to the left. As understood above, this phenomenon is happen because of the line-by-line scanning.

This image distortion may be reduced by shortening a read-out time for one line. However, to realize faster read-out speed it is necessary to use expensive processors. Another solution to avoid the moving object distortion is to use a mechanical shutter. But it also increases a cost and size of the sensor module.

### SUMMARY OR THE INVENTION

On this background, the purpose of the present invention is to provide a technology that can be implemented by the low cost and can be used to correct the distortion of the image data which may be caused by the rolling shutter.

According to one aspect of the present invention, there is provided a digital camera apparatus comprising an image sensor; a memory for a long-term storing of a still photograph and/or a video taken by means of the image sensor; a monitor screen for displaying a view taken by means of the image sensor and/or an image data stored in the memory; a graphic controller for displaying a mark on the screen and capable of skewing the mark on the screen; a user interface for supplying to the graphic controller a signal initiating to change an amount of the skewing of the mark, and; an image processor for correcting an image data based on the amount of the skewing.

By virtue of the present invention, there is provided an efficient, intuitive, and low cost solution for correcting the skewing effect which may be caused by the rolling shutter for the moving object. Of course this invention is beneficial to correct distortions caused by other reasons. And this invention is beneficial to add skewing or other types of effect intentionally for the image data.

If the digital camera apparatus uses the electric rolling shutter technology for taking data, then preferably the mark comprises a line, such as a grid line, which is orthogonal to the pixel scanning direction of the sensor line. So when the sensor's line scanning direction is vertical, (i.e. when the sensor takes data by vertical line by vertical line,) then the grid line should be horizontal. And when the sensor's line scanning direction is horizontal, (i.e. when the sensor takes data by horizontal line by horizontal line,) then the grid line should be vertical. This feature will make the user interface more intuitively. The correction for the image data may be performed by skewing the image data so as to compensate the skewing of the mark. In one embodiment the image processor applies a parallelogram correction to the image data; the amount of parallelogram correction is decided by the amount of the skewing of said mark. The image correction can be applied for preview images, shooting images, and stored images, and both for still pictures and videos.

In another aspect of the present invention, there is provided a computer program for a digital camera apparatus comprising an image sensor, a user interface, a memory for a long-term storing of a still photograph and/or a video taken by means of the image sensor, and a monitor screen for displaying a view taken by means of the image sensor and/or an image data stored in the memory, wherein the computer program instructing the digital camera apparatus to display a mark on the screen; to skew the mark on the screen in response to an input from the user interface, and; to correct an image data based on the amount of the skewing. This computer program can be sold solely through Internet or cellular network, or together with digital cameras or other imaging devices by installed in their memory.

In further aspect of the present invention, there is provided a method for digitally correcting a skewed image data, the method comprising the steps of: presenting a mark over the skewed image on the screen; skewing said mark on screen according to the skewness of on the image data, and; applying a parallelogram correction to the image data; the amount of parallelogram correction is decided by the amount of the skewing of said mark.

### BRIEF DESCRIPTION OF DRAWINGS

FIG. 1 illustrates an electric rolling shutter of a CMOS sensor.

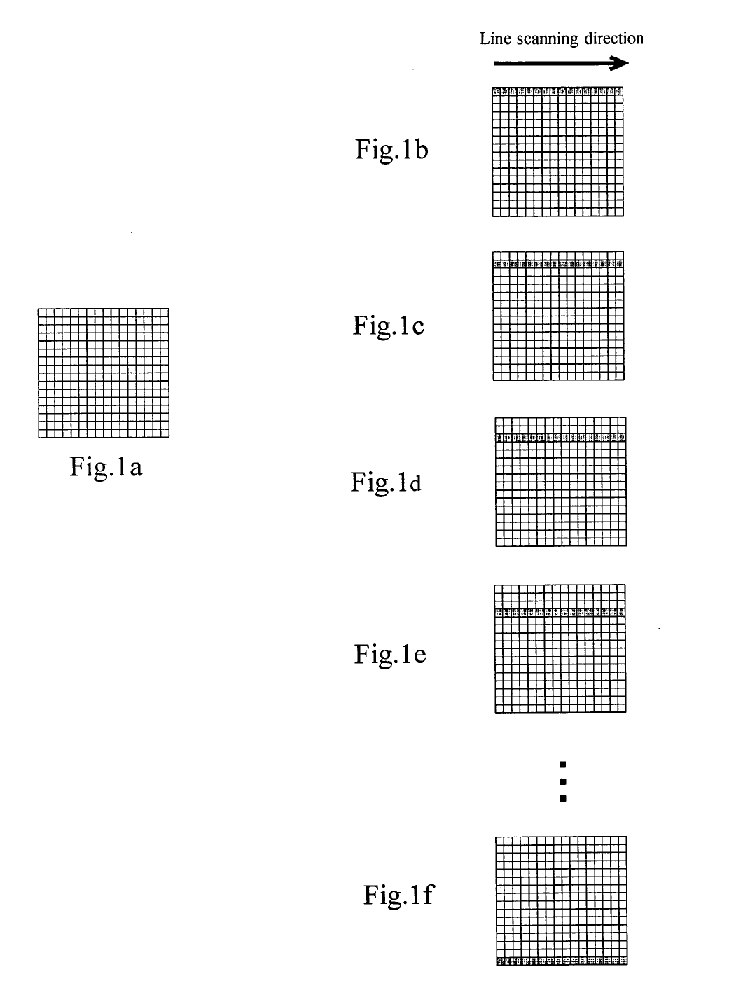

FIG. 2 illustrates a moving object distortion.

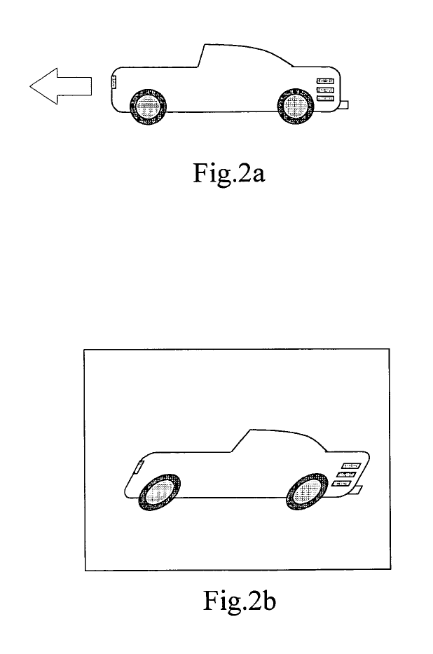

FIG. 3 illustrates exterior appearances of the imaging phone 1 according to the preferred embodiment.

FIG. 4 is a schematic hardware diagram of imaging phone 1.

FIG. 5 is a figure used for explaining the image correction function of the present invention.

FIG. 6 is a figure for explaining an example of image correction.

FIGS. 7-9 illustrate alternative example marks of the vertical grid 31 and user interface for skewing the marks.

FIG. 10 is a flow chart to explain the operations of the imaging phone 1 for taking a still picture or a video.

FIG. 11 is a flow chart to explain the operations of the imaging phone 1 for correcting the rolling shutter effect for the stored image data.

### DETAILED DESCRIPTION OF THE PREFERRED EMBODIMENT

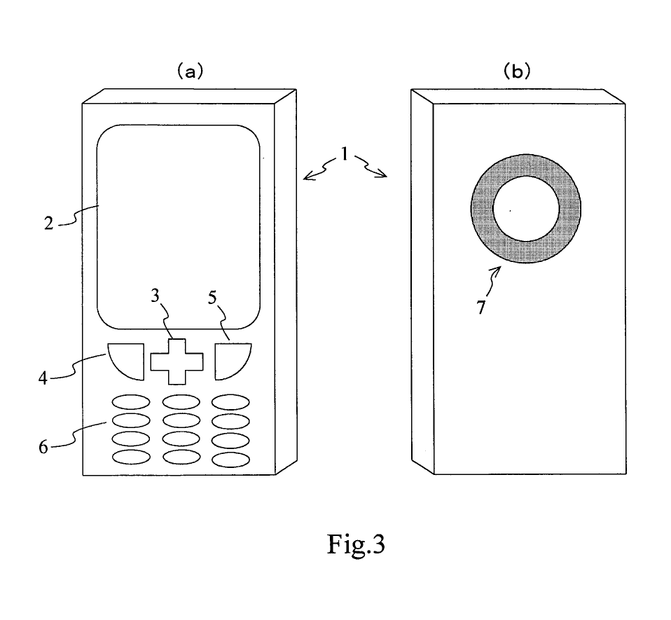

Embodiments of the present invention will now be described by way of example only and with reference to accompanying drawings. FIG. 3 illustrates exterior appearances of the imaging phone 1 according to the preferred embodiment. Imaging phone 1 comprises in its front surface a monitor screen 2, a cross key 3, a left key 4, a right key 5, and numeric keys 6. Imaging phone 1 also comprises in its back surface a digital camera module 7. Cross key 4 comprises four switches in its four arms respectively, so it can be a part of a user interface capable of supplying four independent signals. Right key 5 is used for initiating and receiving a call, and left key 4 is used for ending a call. Numeric keys 6 are used for inputting telephone numbers or mail texts. Cross key 4, left key 4, right key 5, and numeric keys 6 are used, by alone or combination with other keys, for accessing and operating various functions of the imaging phone 1, e.g., phonebook, scheduler, memo, file manager, clock, music player, e-mail, messaging (SMS or MMS), taking a still picture or video, picture and video manager.

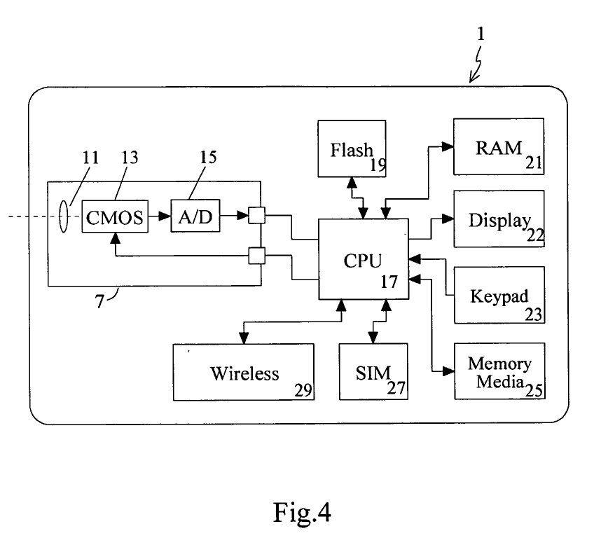

FIG. 4 is a schematic hardware block diagram of imaging phone 1. Imaging phone 1 comprises CPU 17 and flash memory 19. Flash memory 19 contains software for instructing the CPU 17 to perform and control wide range of functions of the imaging phone 1. Connecting to CPU 17, the imaging phone 1 comprises monitor screen 2, digital camera module 7, RAM 21, display 22 having the screen 2 which is shown in FIG.3, keypad 23 including cross key 4, left key 4, right key 5, and numeric keys 6 shown in FIG.3, Memory media 25, SIM card 27, and wireless communication module 23. Memory media 25 is a removable memory media such as MMC card or SD card, and used for storing various information including still photograph and videos taken by means of camera module 7. SIM card 27 contains user information required for cellular telecommunication. Wireless communication module 23 comprises a baseband processor, RF circuits, and antennas, and takes in charge of cellular telecommunication.

The camera module 7 comprises lens 11, CMOS sensor 13, and AID converter 15. Lens 11 converges incident light on CMOS sensor 13. CMOS sensor 13 comprises a RGB Bayer color filter, and converts incident light to electric signals representing R,G, and B. Data taking by the CMOS sensor 13 is performed by way of the electric rolling shutter.

The output signals of the CMOS sensor 13 may be amplified and converted to the digital data by A/D converter 15. The output data of the camera module 7 is temporarily stored in RAM 21, and then is used for further processing. During the camera function of the imaging phone 1 is activated, the imaging phone 1 has a preview mode and a shooting mode. The shooting mode is a mode for taking photographs or videos and storing the taken photographs or videos in Memory media 25. The preview mode is a mode for preparing of the real shooting, i.e. for deciding a frame to be taken or for focusing. So in the preview mode an image data outputted from the camera module will not be stored in Memory media 25, but merely displayed on the screen 2. In the preview mode, CPU 17 controls CMOS sensor 13 to perform data acquisition by lower resolution, e.g. a resolution of the screen 2, but to perform 15 times shooting per a second. So in this embodiment the frame rate of the preview mode is 15 fps. In the shooting mode and when the user takes a still picture, the CPU 17 controls the CMOS sensor 13 to perform data acquisition by using maximum resolution, and the CPU 17 applies a color filter array (CFA) interpolation to the digital data from the camera module and constructs a still picture. CPU 17 is also in charge of creating thumbnail images and compressing image data. Those operations of the CPU 17 are performed according to the instructions of software stored in the flash memory 19.

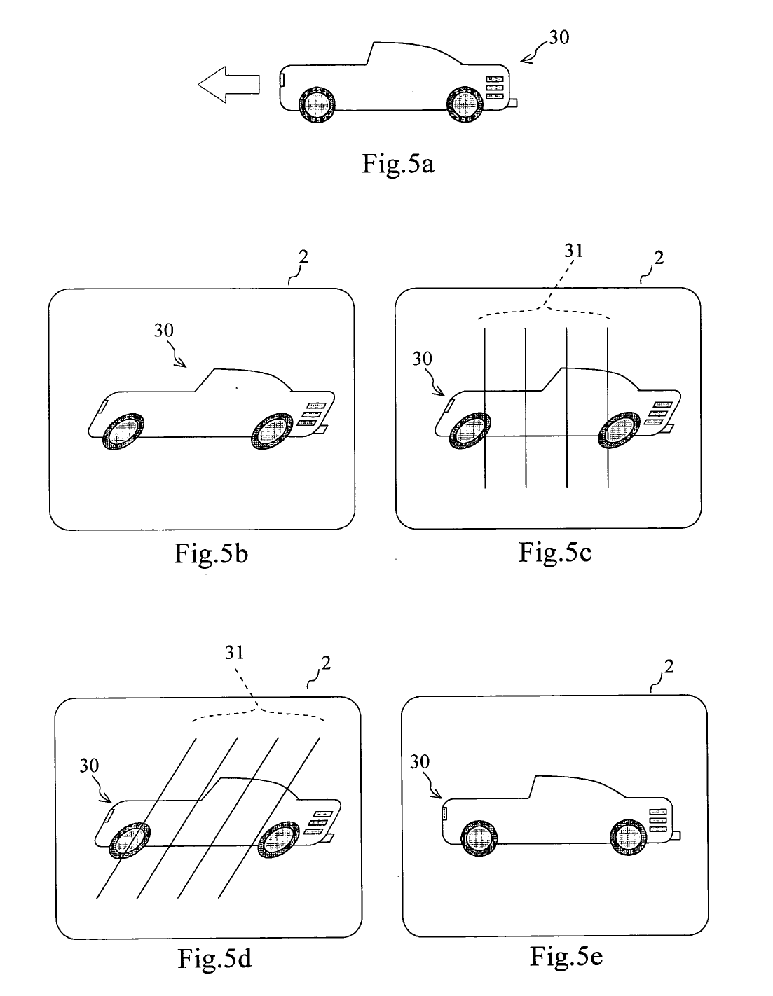

Referring to FIG. 5a-5e, the function of image correction provided by the present invention will be explained next. Suppose the user tries to take a picture or video of a car 30 moving toward left of the figure as illustrated in FIG. 5a. Turning the imaging phone 1 into the preview mode and aiming the lens 11 of the imaging phone 1 to the car 30, the user will find the car 30 is displayed in the screen 2 in skewed manner as illustrated in FIG. 5b. (Please understand that in the figures the phenomenon may be too emphasized as compared to the real situation for the easy understandings.) This distortion is the effect of rolling shutter of the CMOS sensor as explained above.

At this point, CPU 17 displays, by the instruction of the software stored in the flash memory 19, grid line 31 over the preview image on the screen 2 (FIG. 5c). The grid 31 is displayed so as to be orthogonal to the pixel scanning direction of a sensor line. In this example, the grid line 31 is vertical in relation to the viewfinder, because the scanning direction of the CMOS sensor 13 is horizontal in relation to the viewfinder, i.e. the CMOS sensor 13 takes data one horizontal line by one horizontal line. The user can skew the vertical grid 31 on the screen 2 by manipulating the cross key 3. The user should skew the vertical grid 31 so as to align the grid 31 with the skewed vertical line of the car 30 in the screen 2 (FIG. 5d). After the user satisfies the alignment of the vertical grid 31 and the car 30, the CPU 17 and the software in the flash memory 19 performs the image correction so as to compensate the effect of the rolling shutter (FIG. 5e). The image correction is initiated by the instruction of the user through the keypad 23. The amount of image correction is decided based on the amount of the skewing of the vertical grid 31. And the image correction may be performed by skewing the image data so as to compensate the skewing of the mark. In the example of FIG. 5, the correction can be performed by applying a parallelogram correction to the image data. In another example more complicated algorithms may be used. Then the skewing distortion of the car image in the screen 2 will be improved as shown in FIG. 5e. Although the background image will be then skewed, the object which the user really wants to take will not be skewed so much after the correction. The image correction can be performed for the preview images, image data (still photographs or videos) taken in the shooting mode, and image data that is already taken and stored in the Memory media 25. After the correction the shape of the image data may be parallelogram. To reshape it to rectangle, the CPU 17 may crop side part of the corrected image data.

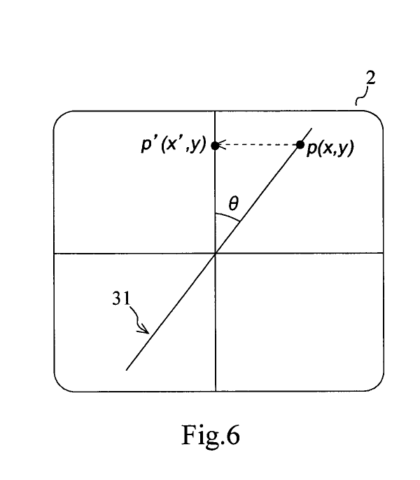

Referring to FIG. 6, an example of the way of image correction performed in FIG. 5e will be explained the next. Suppose a coordinate of a data point of the image data to be corrected is represented by p(x,y), and the angle of the y-axis and the vertical grid 31 is represented by θ. Then the coordinate of the same data point after the correction p′(x′,y′) can be obtained as follows:
x′=x−y·tanθ
y′=y

The image correction can be performed the above transformation for all the data points of the image data.

As the explained image correction function is implemented by software, it can be implemented without requiring any additional hardware or faster readout circuit. Therefore this image correction can be implemented with minimum cost. As understood, this distortion correction can be used for preview images, shooting images, and stored images, and both for still pictures and videos.

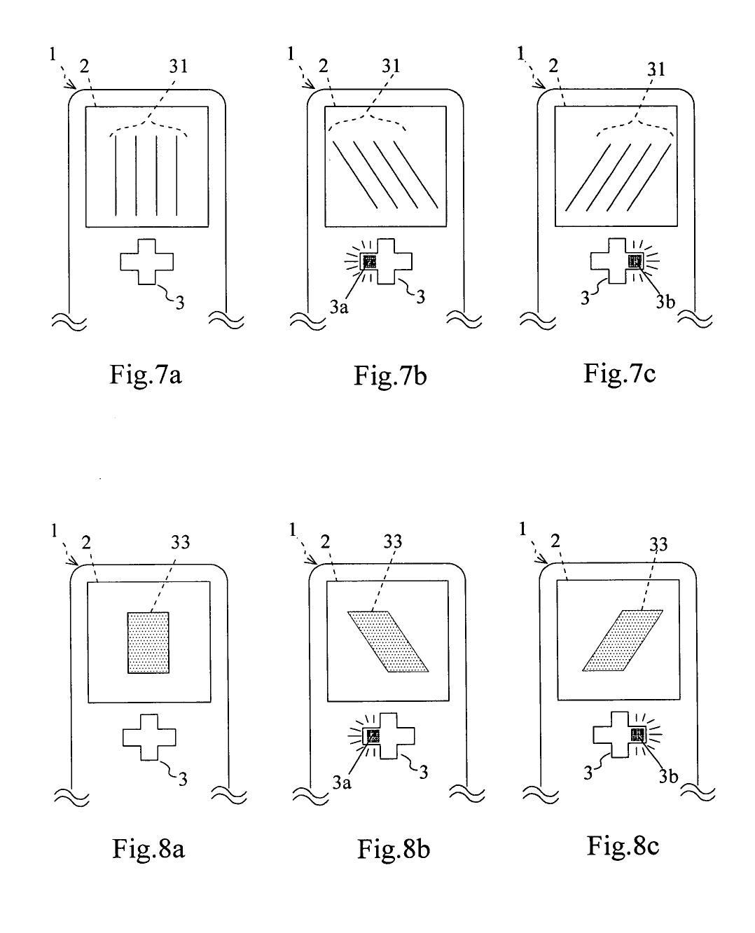

Referring to FIG. 7-9, the operation of user interface and other examples of the grid 31 will be explained. FIG. 7a-7c illustrates the same vertical grid example as shown in previous figures. A signal generated by pressing the left arm 3a of the cross key 3 will initiate the CPU 17 to tilt the vertical grid 31 to the left as illustrated in FIG. 7b. Also a signal generated by pressing the right arm 3b of the cross key 3 will initiate the CPU 17 to tilt the vertical grid 31 to the right as illustrated in FIG. 7c. As the user can check the amount of skewing by aligning the vertical grid, the user can recognize the amount of skewing very intuitively. And user can decide the amount of correction intuitively because what the user has to do is just to skew the vertical grid.

In spite of the vertical grid 31, it may be possible to use a rectangle 33 as illustrated in FIG. 8a. Similar to the example of vertical grid 31, the user can skew the rectangle 33 to the left by pressing the left arm 3a of the cross key 3 as illustrated in FIG. 8b. Also by pressing the right arm 3b of the cross key 3, the user can skew the rectangle 33 to the right as illustrated in FIG. 8c.

In spite of the rectangle 33, a circle 35 having a vertical line may be utilized as illustrated in FIG. 9a. Similar to the example of vertical grid 31, the user can rotate the circle 35 to the left by pressing the left arm 3a of the cross key 3 as illustrated in FIG. 9b. Also by pressing the right arm 3b of the cross key 3, the user can rotate the circle to the right as illustrated in FIG. 9c. The amount of rotation is utilized for the image correction.

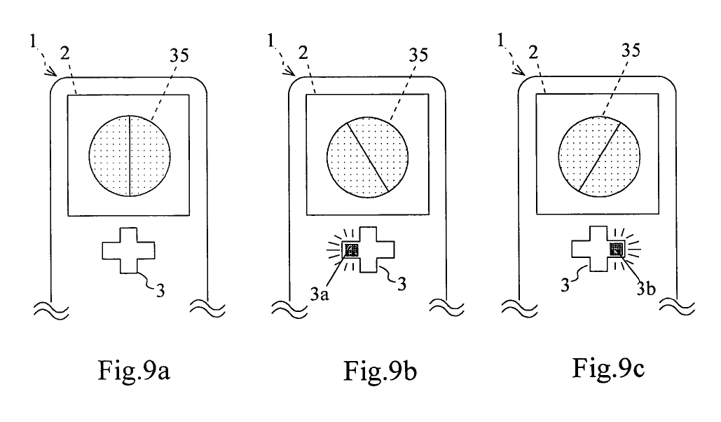

Referring to FIG. 10, the flow of the operations of the imaging phone 1 for taking a still picture or a video will be explained next. In step S110 the camera function is activated by the predetermined manipulation of the keypad 23. Immediately after the camera activation, the imaging phone will enter into the preview mode (step S120). In step S120 CPU 17 controls the CMOS sensor 13 to perform data dating by 15 fps and minimum resolution. The image data taken by means of the CMOS sensor 13 will be displayed on the screen 2 after the predetermined data processing. In step S130, the user manipulates the keypad 23 to make CPU 17 to display the vertical grid 31 over the preview image on the screen 2. Then the user manipulates the cross key 3 to skew the vertical grid on the screen 2 as illustrated in FIG. 7b and 7c (step S140). After the user satisfies the amount of skewing, the user manipulates the keypad 23 to take a photograph or start video recording (step S150). In response to the predetermined keypad manipulation, the imaging phone 1 enters into the shooting mode, and the CPU 17 controls the CMOS sensor 13 to perform data taking. The output signals of the CMOS sensor is amplified, converted to the digital signal, and white balanced (steps S160). In step S170 the CPU 17 applies CFA interpolation for the digital data to construct a frame of picture data. In case of the video recording the step S170 may not be applied. In step S180, the CPU 17 performs the distortion correction to compensate the effect of rolling shutter as explained above with references to FIG. 5-9. In step S190 the CPU 17 crops the edges of the corrected image data to reshape the image data to rectangle. In step S200 the CPU 17 performs further processing to the image data, e.g. gamma correction, thumbnail creation, formatting the image data to the predetermined format, or compressing. In step S210 the processed image data is stored in the Memory media 25. The thumbnail image may be displayed on the screen 2. The CPU 17 performs all the operation by the instruction of the software stored in the flash memory 19.

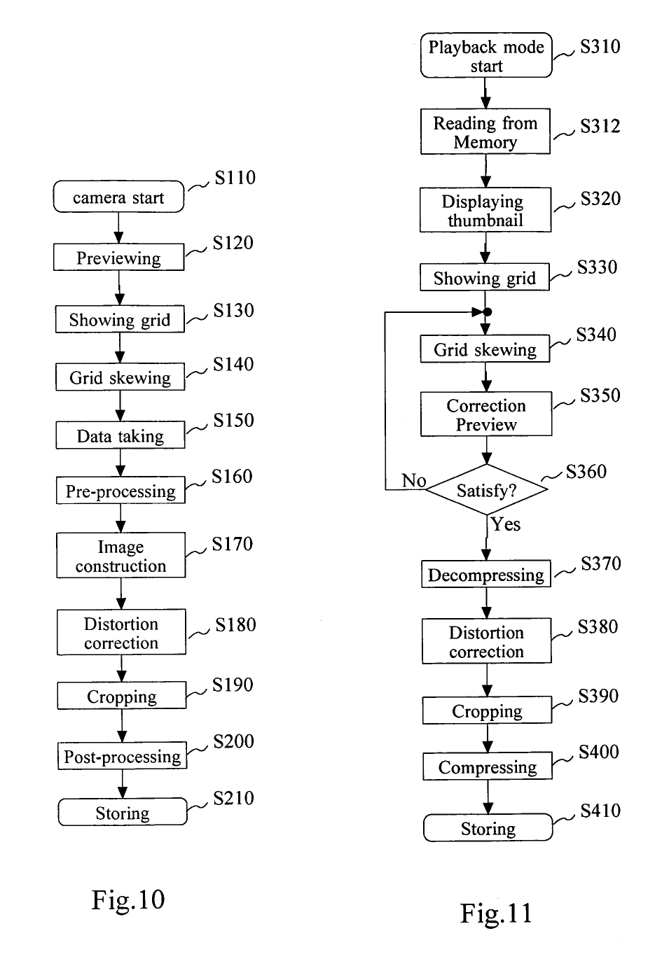

Referring to FIG. 11, the flow of the operations of the imaging phone 1 for correcting the rolling shutter effect for the image data stored in Memory media 25 and taken in past time. In step S310 the imaging phone enters into the playback mode. In the playback mode the user can retrieve still pictures or videos stored in the Memory media 25 (step S312), and display (replay) the desired one on the screen 2 (step S320). In the Memory media preferably the image data comprises a compressed data of the full size image and its thumbnail image. In this case what the CPU 17 has to do is to display the thumbnail data on the screen 2, and need not to create a data for the displaying, In step S330, the user manipulates the keypad 23 to make CPU 17 to display the vertical grid 31 over the thumbnail image on the screen 2. Then the user manipulates the cross key 3 to skew the vertical grid on the screen 2 as illustrated in FIG. 7b and 7c (step S340). In step S350 CPU 17 performs distortion correction for the thumbnail image so that the user can check whether the user satisfies the result of correcting the skewed effect or not. If the user does not satisfy then the CPU 17 cancel the distortion correction performed for the thumbnail image and back to the step S340 according to the user's instruction. If the user satisfies, then the user manipulates the keypad 23 to make CPU 17 to perform the image correction. In response to the manipulation of the keypad 23 the CPU 17 decompress the full size image data (step S370), performs the distortion correction as explained above with references to FIG. 5-9. In step S390 the CPU 17 crops the edges of the corrected image data to reshape the image data to rectangle. In step 400 the CPU 17 compressing the corrected image data. In step S410 the CPU 17 stores the compressed image data in the Memory media 25 with its thumbnail image which is also reflect the effect of the distortion correction. The CPU 17 performs all the operation by the instruction of the software stored in the flash memory 19.

According to the imaging phone 1 the user can compensate the skewing effect caused by the rolling shutter effectively. This function can be implemented without requiring any additional hardware or faster readout circuit. Therefore this function may be implemented with minimum cost. Further the user interface is very intuitive, thus the use can easily recognize the amount of skewing of the image and the result of correction. Still further the imaging phone 1 can apply the distortion correction for preview images, shooting images, and stored images, and both for still pictures and videos.

Please note that various modifications may be made without departing from the scope of the present invention. This invention can be applied for not only the imaging phones but also the dedicated digital cameras or camera-equipped electronic devices such as PDAs or music players. Also the above-explained distortion correction method can be implemented in an independent computer program product. The grid is not limited to the example illustrated in FIG. 7-9. As long as it can tell to the system the amount of distortion any types of marks can be used. The algorithm for the skewed-effect correction is not limited to the above-explained method. Any algorithm can be used as long as the result of correction is preferable. Whilst endeavoring in the foregoing specification to draw attention to those features of the invention believed to be of particular importance, it should be understood that the applicant claims protection in respect of any patentable feature of combination of features hereinbefore referred to and/or shown in the drawings whether of not particular emphasis has been placed thereon.

1. A digital camera apparatus comprising:
an image sensor;
a memory for a long-term storing of a still photograph and/or a video taken by means of the image sensor;
a monitor screen for displaying a view taken by means of the image sensor and/or an image data stored in the memory;
a graphic controller for displaying a mark on the screen and capable of skewing the mark on the screen,
a user interface for supplying to the graphic controller a signal initiating to change an amount of the skewing of the mark, and;
an image processor for correcting an image data based on the amount of the skewing.

2. A digital camera apparatus according to claim 1, wherein:
the camera apparatus using an electric rolling shutter technology for taking data, and
said mark comprising a line which is orthogonal to the pixel scanning direction of the sensor line.

3. A digital camera apparatus according to claim 1, wherein said user interface being capable of supplying a signal for skewing the mark in one direction and a signal for skewing the mark in another direction.

4. A digital camera apparatus according to claim 1, wherein said image processor correcting the image data by skewing the image data so as to compensate the skewing of the mark.

5. A digital camera apparatus according to claim 1, wherein said image processor applying a parallelogram correction to the image data; the amount of parallelogram correction is decided by the amount of the skewing of said mark.

6. A digital camera apparatus according to claim 1, wherein said image processor reshaping the corrected image data to be a rectangle by cropping a side part of the corrected image data.

7. A digital camera apparatus according to claim 1 further comprising:
a shooting mode for storing an image data taken by means of the image sensor in the memory, and;
a preview mode for displaying an image data taken by means of the image sensor on the screen without storing the image data in the memory;
and wherein:
said graphic controller being arranged to display and skew the mark on the screen over images obtained in the preview mode, and;
said image processor being arranged to perform said correcting for an image data taken in the shooting mode.

8. A digital camera apparatus according to claim 1 wherein:
said graphic controller being arranged to retrieve an image data stored in the memory, to display an thumbnail of the image data on the screen, and to display and skew the mark over the thumbnail; and
said image processor being arranged to perform said correcting for the retrieved image data.

9. A computer program for a digital camera apparatus comprising
an image sensor;
a user interface;
a memory for a long-term storing of a still photograph and/or a video taken by means of the image sensor, and;
a monitor screen for displaying a view taken by means of the image sensor and/or an image data stored in the memory;
wherein the computer program instructing the digital camera apparatus:
to display a mark on the screen; to skew the mark on the screen in response to an input from the user interface, and;
to correct an image data based on the amount of the skewing.

10. A computer program according to claim 9 wherein: the digital camera apparatus further comprising:
a shooting mode for storing an image data taken by means of the image sensor in the memory, and;
a preview mode for displaying an image data taken by means of the image sensor on the screen without storing the image data in the memory;
and the computer program instructing the digital camera apparatus:
to skew the mark on the screen over images obtained in the preview mode, and;
to perform said correcting for an image data taken in the shooting mode.

11. A computer program according to claim 9, wherein the computer program instructing the digital camera apparatus to retrieve an image data stored in the memory, to display an thumbnail of the image data on the screen, to display and skew the mark over the thumbnail, and to perform said correcting for the retrieved image data.

12. A method for digitally correcting a skewed image data taken by a camera apparatus using the electric rolling shutter, the method comprising the steps of:
presenting a mark over the skewed image on the screen,
skewing said mark on screen according to the skewness of on the image data, and;
applying a parallelogram correction to the image data; the amount of parallelogram correction is decided by the amount of the skewing of said mark.
